(19) United States
(12) Patent Application Publication
(10) Pub. No.: US 2025/0265496 A1
(43) Pub. Date: Aug. 21, 2025

(54) METHOD AND APPARATUS FOR PERFORMING AUTOMATED DEIDENTIFICATION OF DOCUMENTS

(71) Applicant: SRI International, Menlo Park, CA (US)

(72) Inventors: Edmond CHOW, Encinitas, CA (US); Adrienne WOODS, Waltham, MA (US); Dayne FREITAG, Descanso, CA (US)

(21) Appl. No.: 18/984,081

(22) Filed: Dec. 17, 2024

Related U.S. Application Data
(60) Provisional application No. 63/555,304, filed on Feb. 19, 2024.

(51) Int. Cl. G06N 20/00

(52) U.S. Cl. CPC G06N 20/00

(57) ABSTRACT

Method and apparatus for deidentifying a document comprising a field analyzer for identifying at least one structured field and at least one unstructured field within a document. An attribute analyzer, using a first machine learning model and the identified at least on structured field and at least one unstructured field, identifies at least one attribute within the document. An unstructured field analyzer, using a second machine learning model and the identified at least one attribute from the at least one structured field, identifies at least one attribute within the at least one unstructured field. A redactor redacts the identified at least one attribute in the at least one structured field and the at least one unstructured field to form a deidentified document.

### RELATED APPLICATION

This application claims benefit to U.S. Provisional Patent Application Ser. No. 63/555,304, filed 18 Feb. 2024 and entitled “Automated De-Identification of Semi-Structured Documents,” which is hereby incorporated herein in its entirety by reference.

### FIELD

Embodiments of the present principles generally relate to machine learning models and, more particularly, to a method and apparatus for performing automated deidentification of documents using machine learning models.

### BACKGROUND

Many domains, such as education, healthcare, finance, human resources, etc., maintain records on the status of individuals, often using forms that mix structured fields (e.g., structured headers, tables or labels) and unstructured fields where free form text is located. Analytics applied to archives of such forms can offer important and impactful insights (e.g., what pedagogical interventions work best for students with particular difficulties). Analysis of such archives generally requires the data within the forms to be deidentified, i.e., remove any personally identifying information (PII).

Manually performing deidentification is time consuming, costly and fraught with errors. Consequently, various techniques have been developed to automate the deidentification of documents. Current automated deidentification systems use a combination of named entity recognition (NER) and a library of string patterns (e.g., phone numbers, addresses and social security numbers) to identify PII. Such tools are generally limited to searching and redacting generic, predefined types of PII.

Thus, there is a need for method and apparatus for performing deidentification in a more flexible manner.

### SUMMARY

Embodiments of the present invention generally relate to a method and apparatus for performing automated deidentification of a document using machine learning techniques as shown in and/or described in connection with at least one of the figures.

More specifically, embodiments of the invention include a method, apparatus and computer readable media configured to process documents using machine learning comprising receiving at least one document having at least one structured field and at least one unstructured field and identifying at least one attribute in the structured field that may be used to find at least one attribute in the at least one unstructured field using machine learning techniques. Redacting the identified attributes from the document to produce a deidentified document.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a block diagram of an exemplary computing system for performing automated deidentification of documents in accordance with at least one embodiment of the invention;

FIG. 2A depicts an exemplary format of a semi-structured individualized education program (IEP) document for processing using the system of FIG. 1 in accordance with at least one embodiment of the present invention;

FIG. 2B depicts the exemplary semi-structured IEP document of FIG. 2A that has been deidentified using the system of FIG. 1 in accordance with at least one embodiment of the present invention;

FIG. 3 depicts a functional block diagram of a deidentification server of FIG. 1 in accordance with at least one embodiment of the invention;

FIG. 4 depicts a flow diagram of a method of training at least one machine learning model in accordance with at least one embodiment of the invention

FIG. 5 depicts a flow diagram of a method of performing automated deidentification of documents using at least one machine learning model in accordance with at least one embodiment of the invention;

FIG. 6 depicts a computer system that can be utilized in various embodiments of the present invention to implement the computing device according to one or more embodiments;

FIG. 7A depicts an exemplary format of a semi-structured medical document for processing using the system of FIG. 1 in accordance with at least one embodiment of the present invention;

FIG. 7B depicts the exemplary semi-structured medical document of FIG. 7A that has been deidentified using the system of FIG. 1 in accordance with at least one embodiment of the present invention;

FIG. 8A depicts an exemplary format of a semi-structured employment document for processing using the system of FIG. 1 in accordance with at least one embodiment of the present invention; and

FIG. 8B depicts the exemplary semi-structured employment document of FIG. 8A that has been deidentified using the system of FIG. 1 in accordance with at least one embodiment of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses, systems and computer readable media for creating and/or operating a computing device to perform automated document deidentification using machine learning techniques. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments of a computing device for performing automated document deidentification described herein enables many capabilities and applications not previously achievable thru any individual computing system. Embodiments of the disclosed computing device address the problem of costly, time-consuming and/or limited manual and automated deidentification techniques. Embodiments of the invention are especially useful in performing automated deidentification of semi-structured documents where the documents comprise at least one structured field and at least one unstructured field.

Various embodiments comprise at least one machine learning model that is trained with semi-structured documents and/or synthetic data comprising at least one structured field and at least one unstructured field. The at least one structured field comprises attributes that identify a person and/or contain personal information such as, but not limited to, name, physical address, email address, websites, student or school identifier, employment or school information, social security number (SSN), driver's license number, date of birth (DOB), credit card information, and the like. The at least one unstructured field comprises a region having free form text, for example, but not limited to, paragraphs, sentences, phrases, and the like. Embodiments of the invention train a machine learning model using a plurality of semi-structured documents and/or synthetic data to identify attributes such as personal information or other sensitive information in the structured field(s), then find those attributes in the unstructured field(s) and analyze the text proximate the identified attribute in the unstructured field(s) to confirm whether the attribute is truly personal or sensitive information. The trained machine learning model may then be used to identify attributes in new documents and redact the identified attributes to deidentify the documents.

The aforementioned embodiments and features are now described below in detail with respect to the Figures.

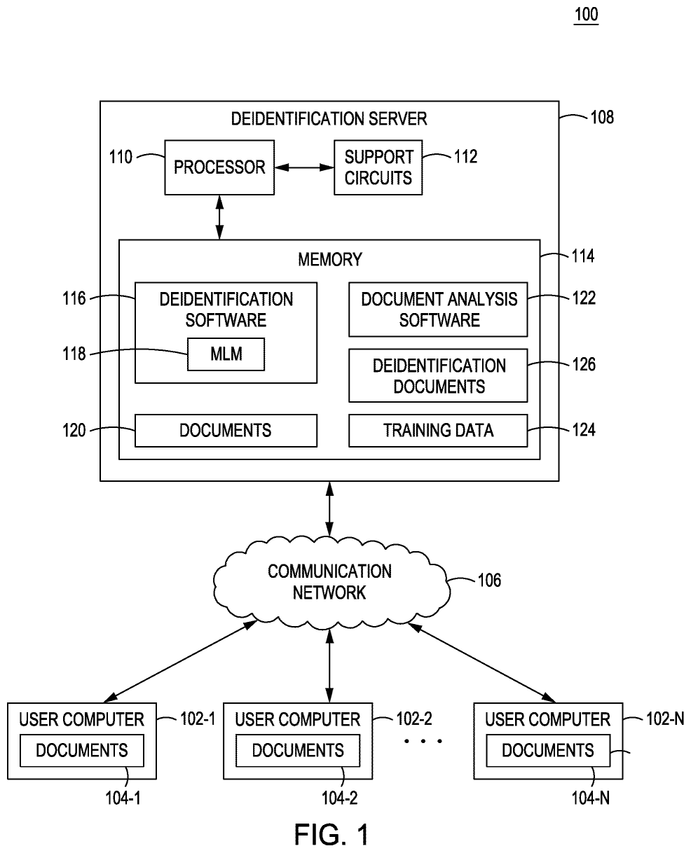

FIG. 1 depicts a block diagram of an exemplary computing system 100 for performing automated deidentification of documents in accordance with at least one embodiment of the invention. The system 100 comprises a plurality of user computers 102-1, 102-2, . . . , 102-N (collectively referred to as user computers 102), a communications network 106, and a deidentification server 108. The deidentification server 108 may comprise one or more servers. In one embodiment, the user computers 102 store and/or generate documents 104-1, 104-2, . . . , 104-N that are to be deidentified by the deidentification server 108. In other embodiments, the server 108 may contain a database of documents 120 to be deidentified. In some embodiments, the documents 104 are transmitted through the communications network 106 to become documents 120 and, in other embodiments, the user computers 102 may retain their documents 104 locally and utilize a web-based service executing on the deidentification server 108 to deidentify the documents 104 without supplying the documents 104 to the server 108. In this manner, processing of the documents may be performed securely in a siloed or compartmentalized manner.

The user computers 102 may be any form of computing device including, but not limited to, desk top computers, lap top computers, tablets, smartphones, and the like. The communications network may be any form of communications network or combination of networks capable of communicating data between the user computers 102 and the server 108 including, but not limited to, a local area network (LAN), a wide area network (WAN), WiFi network, cellular network, and the like.

The deidentification computer 108 comprises at least one processor 110, support circuits (and devices) 112, and memory 114. The at least one processor 110 may be any form of processor or combination of processors including, but not limited to, central processing units, microprocessors, microcontrollers, field programmable gate arrays, graphics processing units, digital signal processors, and the like. The support circuits 112 may comprise well-known circuits and devices facilitating functionality of the processor(s). The support circuits 112 may comprise one or more of, or a combination of, power supplies, clock circuits, analog to digital converters, communications circuits, cache, displays, and/or the like.

The memory 114 comprises one or more forms of non-transitory computer readable media including one or more of, or any combination of, read-only memory or random-access memory. The memory 114 stores software and data including, for example, but not limited to, deidentification software 116, document analysis software 122, documents 120, training data 124 and deidentified documents 126. The deidentification software 116 comprises at least one machine learning model (e.g., a neural network) 118. The memory 114 may also comprise various well-known application software (not shown) such as, but not limited to, an operating system, web server software, peripheral drivers, and the like.

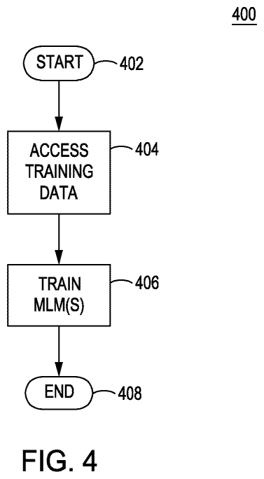

Prior to operating the deidentification server 108, at least one machine learning model 118 is trained using the training data 124 to perform document deidentification as described in detail below (See FIG. 4 and accompanying text). Once trained, the documents 120 (and/or 104) are processed by the at least one processor 110 executing the deidentification software 114 and its at least one machine learning model 118 to deidentify the documents 120 and/or 104. Specifically, the processor 110 identifies specific attributes of the documents (e.g., personally identifying information (PII) or other sensitive information) and redacts those attributes from the documents to create the deidentified documents 126. The documents may be any form of mixed structure document that contains attributes representing PII or other sensitive information including, but not limited to, medical records, education records, financial records, resumes, personnel records, classified documents, legal documents, government documents, and the like. In one particular embodiment, the system is used for deidentifying individualized education programs (IEPs) that generally contain student and family PII and other sensitive information.

A mixed structure document is a document with at least one known field containing attributes representing PII or other sensitive information and at least one unstructured field where free-form text is located. A mixed structure document may also be a document that has at least one unstructured field and related metadata that is available for identifying attributes representing PII or other sensitive information.

In one embodiment, the mixed structure documents have a fixed, uniform format defining the location of the attributes in the at least one structured field of the document. In other embodiments, the format is open and the deidentification software is capable of determining the location of the attributes in the at least one structured field.

Once the documents 120 (and/or 104) have been deidentified, the deidentified documents 126 may be returned to the user computers 102 or stored at the server 108 or stored elsewhere. These deidentified documents may not be analyzed by, for example, executing the document analysis software 114 such that the information contained in the documents may be analyzed in an anonymized manner. Although the document analysis software 114 is shown as being executed on the server 108, this software may be executed anywhere-remotely on another server, on the user computers, on a researcher's computer, and the like. The analysis may look for trends or insights in the anonymized data as described below.

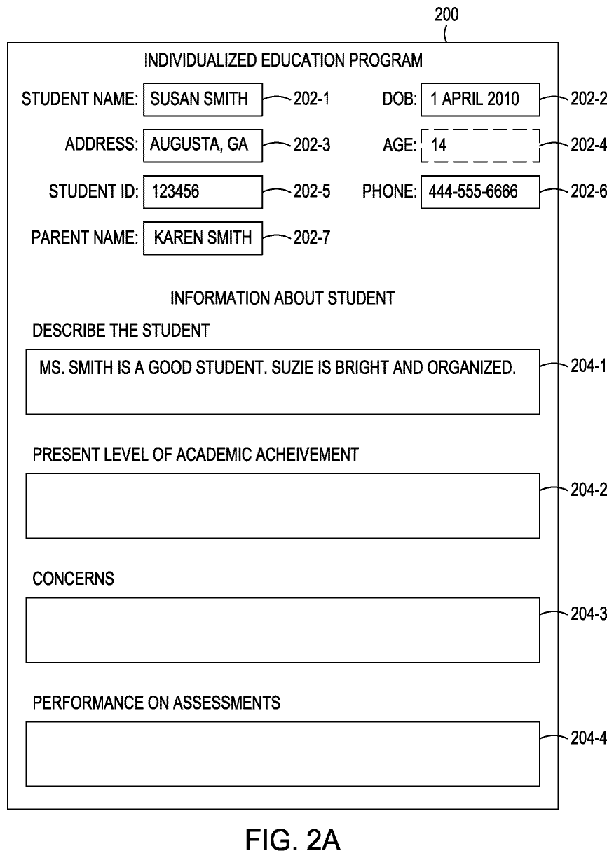

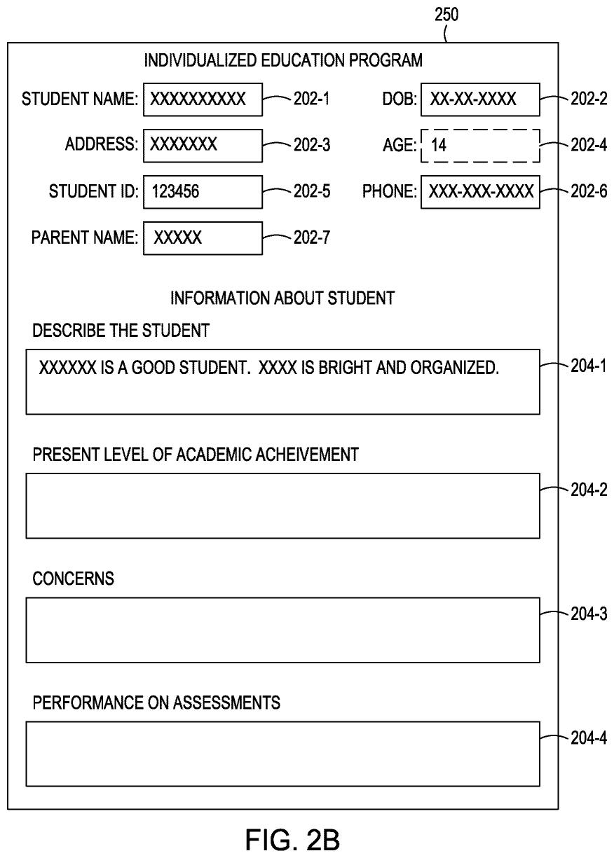

FIG. 2A depicts an exemplary format of a semi-structured IEP document 200 for processing using the system 100 of FIG. 1 in accordance with at least one embodiment of the present invention. The depicted exemplary document 200 comprises at least one structured field 202-1, 202-2, 202-3, 202-4, 202-5, 202-6, 202-7 (collectively structured field 202) and at least one unstructured field 204-1, 204-2, 202-3, 202-4 (collectively unstructured field 204). The at least one structured field 202 may be a header or a footer within the document 200 or may be metadata from a database. The structured fields contain structured data, e.g., the data is located in a known location. The structured data comprises attributes including PII and other sensitive information such as, but not limited to, student name 202-1, date of birth (DOB) 202-2, address 202-3, age 202-4, student identifier 202-5 (e.g., student identification number, social security number, etc.), phone number 202-6, parent name 202-7 and the like. In some situation, certain structured fields are useful in performing data analysis, such that these fields will not be identified as PII and redacted. For example, age is one such field (as indicated by the dashed box 202-4). Analysts may not redact age (or other attributes such as grade level) so that data may be categorized and analyzed based on the unredacted attribute(s) of the subjects. A user may control which structured fields are to be redacted and which are not to be redacted. Such control is important to the ability to generate data sets for various types of analysis. Other attributes that are not shown may include financial or medical information such as, but not limited to, credit card numbers, financial account numbers, income, patient name, doctor name, diagnoses, drugs used, and the like.

In one embodiment, the deidentification system 100 has knowledge of the location of the at least one structured field 202 (e.g., the documents are forms with a known format) such that the system extracts the attributes at those locations to use in analyzing the at least one unstructured field 204. In other embodiments, the location of the at least one field 202 is not known and the system 100 pre-processes the document to identify the at least one structured field 202. The pre-processing may be accomplished through pattern matching where the system 100 identifies key words that are typically followed by a field containing an attribute of interest. Such words include, but are not limited to, NAME, ADDRESS, ACCOUNT, ID, CARD NUMBER, and the like. When these key words repeatedly occur in a document in the same order, the system 100 deems them to be structured fields. In some embodiments, a human user may direct the system 100 as to where the structured fields are located within a number of documents to train the system 100 to understand where the structured fields are located, i.e., user defined learning. In other embodiments, machine learning algorithms may be used to identify the structured fields through training upon various documents containing structured fields. In another embodiment, the machine learning algorithm may be a large language model (LLM). In other embodiments, the algorithm may use zero shot learning (e.g., find occurrences of a person's name), or use few shot learning (e.g., this field contains a person's name, and this field doesn't) to train generative LLMs. In other embodiments, a standard machine learning approach may be used where a non-generative LLM (e.g., a BERT model) is trained with large amounts of data to recognize attributes. Additionally, the LLM may be trained using instruction tuning where a large LLM is trained specifically on the task-identify attributes).

The at least one unstructured field 204 comprises regions where unstructured, free form text may be entered. In the exemplary document 200, the unstructured fields are where an educator may enter information for an IEP regarding a student such as, but not limited to, a student's strengths 204-1, a student's level of achievement 204-2, concerns 204-3, performance on assessment tests 204-3 and the like. In a medical record, the unstructured field may contain a medical practitioner's diagnosis or notes. In a resume, the unstructured field may contain text describing a person's work history. In financial records, the unstructured field may contain investment goals, income history, expense history, and the like.

FIG. 2B depicts the exemplary semi-structured IEP document 200 of FIG. 2A that has been deidentified to create a deidentified document 250 using the system of FIG. 1 in accordance with at least one embodiment of the present invention. As described in detail below, the deidentification system 100 processes the semi-structured document 200 to determine attributes within the structured fields 202 that are used to identify attributes in the unstructured fields 204. The identified attributes are then redacted to produce the deidentified document 250.

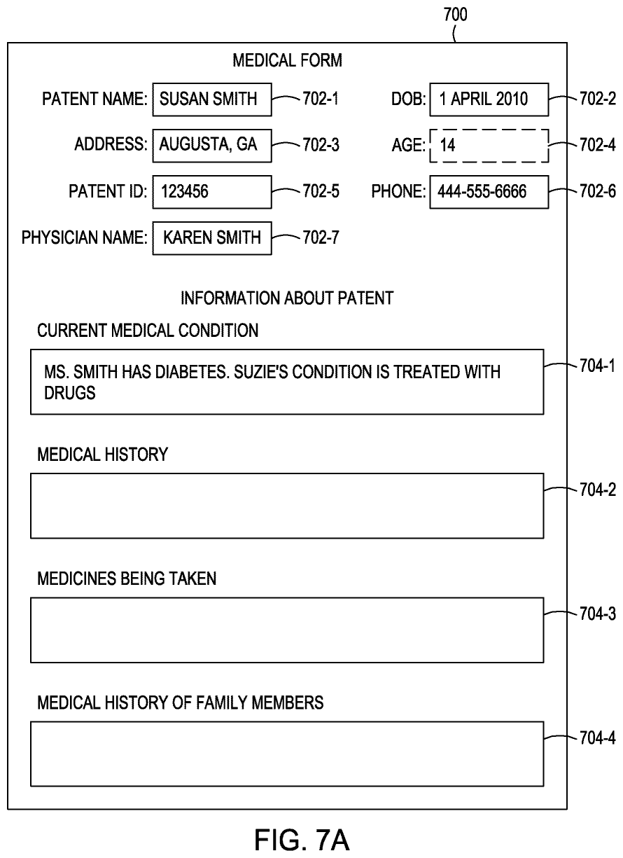

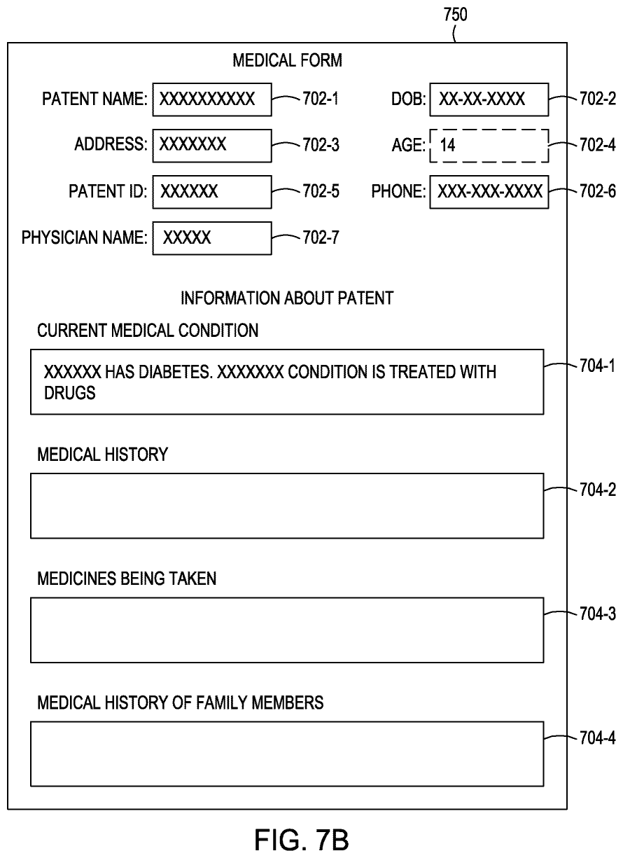

FIG. 7A depicts an exemplary format of a semi-structured medical document 700 for processing using the system 100 of FIG. 1 in accordance with at least one embodiment of the present invention. The depicted exemplary document 700 comprises at least one structured field 702-1, 702-2, 702-3, 702-4, 702-5, 702-6, 702-7 (collectively structured field 202) and at least one unstructured field 204-1, 204-2, 202-3, 202-4 (collectively unstructured field 204). The at least one structured field 202 may be a header or a footer within the document 700 or may be metadata from a database. The structured fields contain structured data, e.g., the data is located in a known location. The structured data comprises attributes including PII and other sensitive information such as, but not limited to, patient name 702-1, date of birth (DOB) 702-2, address 702-3, age 702-4, patient identifier 702-5, phone number 702-6, physician name 702-7 and the like.

FIG. 7B depicts the exemplary semi-structured medical document 200 of FIG. 7A that has been deidentified to create a deidentified document 750 using the system of FIG. 1 in accordance with at least one embodiment of the present invention. As described in detail below, the deidentification system 100 processes the semi-structured document 700 to determine attributes within the structured fields 702 that are used to identify attributes in the unstructured fields 704. The identified attributes are then redacted to produce the deidentified document 750.

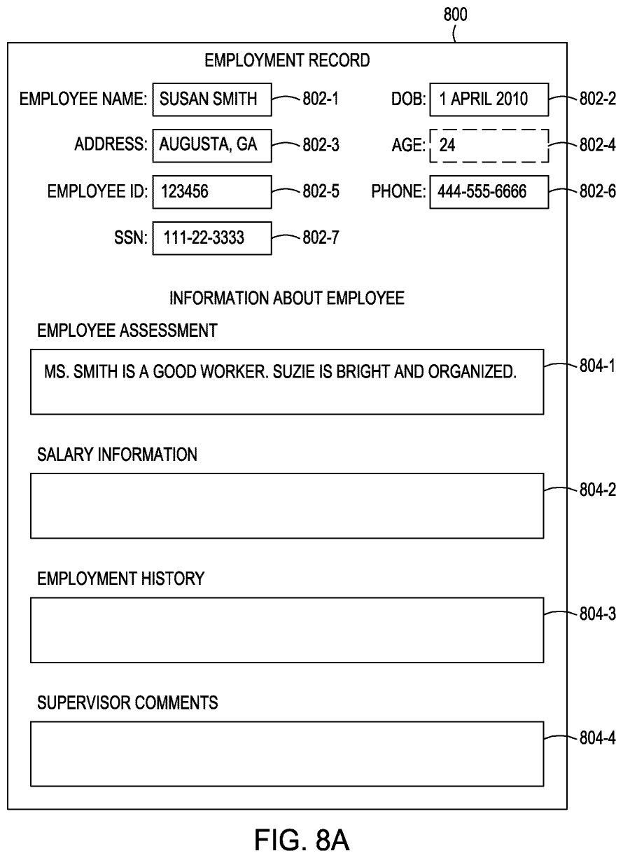

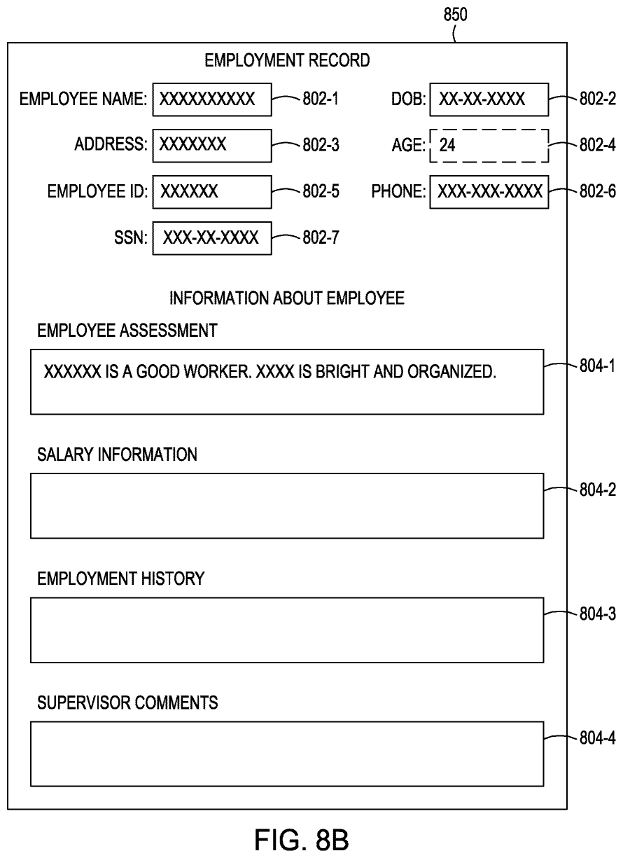

FIG. 8A depicts an exemplary format of a semi-structured employment document 800 for processing using the system 100 of FIG. 1 in accordance with at least one embodiment of the present invention. The depicted exemplary document 800 comprises at least one structured field 802-1, 802-2, 802-3, 802-4, 802-5, 802-6, 802-7 (collectively structured field 802) and at least one unstructured field 804-1, 804-2, 802-3, 802-4 (collectively unstructured field 804). The at least one structured field 802 may be a header or a footer within the document 800 or may be metadata from a database. The structured fields contain structured data, e.g., the data is located in a known location. The structured data 802 comprises attributes including PII and other sensitive information such as, but not limited to, employee name 802-1, date of birth (DOB) 802-2, address 802-3, age 802-4, employee number 802-5, phone number 802-6, social security number (SSN) 802-7, and the like.

FIG. 8B depicts the exemplary semi-structured financial document 800 of FIG. 8A that has been deidentified to create a deidentified document 850 using the system of FIG. 1 in accordance with at least one embodiment of the present invention. As described in detail below, the deidentification system 100 processes the semi-structured document 800 to determine attributes within the structured fields 802 that are used to identify attributes in the unstructured fields 804. The identified attributes are then redacted to produce the deidentified document 850.

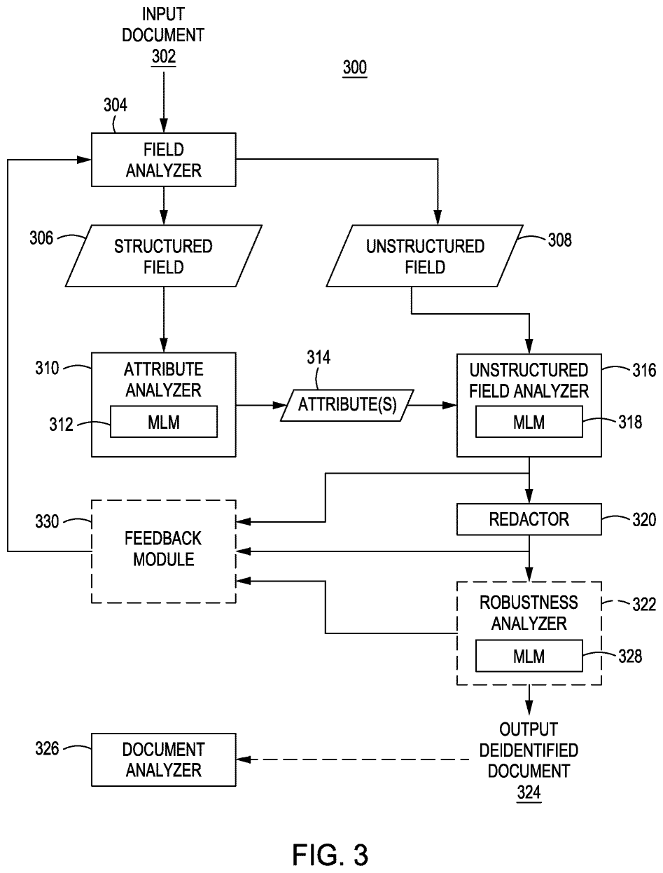

FIG. 3 depicts a functional block diagram of the deidentification server 108 of FIG. 1 when executing the deidentification software 116 in accordance with at least one embodiment of the invention. The server 108, when executing the deidentification software 116, operates upon input documents 302 to produce deidentified documents 324. Each input document 302 is first processed by a field analyzer 304 to identify the structured fields 306 and unstructured fields 308. In one embodiment, the field analyzer 304 knows the locations and field tags (e.g., the type of content in each field) for each structured field. In other embodiments, the field analyzer 304 may identify the location of the fields by searching for identifiers within the document such as key words including name, SSN, DOB, address, phone, and the like that can be used to identify the location of the at least one structured field.

Once the fields are identified, an attribute analyzer 310 uses a first machine learning model (MLM) 312 to identify at least one attributes 314 such as PII (and/or other sensitive information) within the at least one structured field 306. The first MLM 312 may be, for example, a large language model (LLM) that is trained to identify the at least one attribute 314. In other embodiments, the algorithm may use zero shot learning (e.g., find occurrences of a person's name), or use few shot learning (e.g., this field contains a person's name, and this field doesn't) to train generative LLMs. In other embodiments, a standard machine learning approach may be used where a non-generative LLM (e.g., a BERT model) is trained with large amounts of data to recognize attributes. Additionally, the LLM may be trained using instruction tuning where a large LLM is trained specifically on the task-identify attributes). The first MLM 312 is trained to look for variations in the format of names, addresses, numbers and the like as well as misspellings of the information. The first MLM 312 classifies the identified at least one attribute 314 by its type of data, e.g., name, address, SSN, DOB, etc. The attribute analyzer 310 extracts the attributes 314 from the structured fields 306 for use by an unstructured field analyzer 316.

The unstructured field analyzer 316 uses a trained second MLM 318 to identify at least one attribute (PII and/or other sensitive information) located within the unstructured fields 308. The second MLM 318 may be, for example, an LLM that is trained to identify at least one attribute in unstructured fields. In other embodiments, the algorithm may use zero shot learning (e.g., find occurrences of a person's name), or use few shot learning (e.g., this field contains a person's name, and this field doesn't) to train generative LLMs. In other embodiments, a standard machine learning approach may be used where a non-generative LLM (e.g., a BERT model) is trained with large amounts of data to recognize attributes. Additionally, the LLM may be trained using instruction tuning where a large LLM is trained specifically on the task-identify attributes). The second MLM 318 is capable of identifying the at least one attribute, not only from its text, but also from the context within the sentence or clause the PII is located. The second MLM 318 classifies the sentences into types to find sentences that have context that may contain PII even if the PII is not identical to the extracted PII, e.g., partial addresses, nicknames, misspellings, name variations (for example, Sue, Susan, Suzie may identify the same person). For example, an IEP may identify a student in a structured field as “Susan Smith” and in the unstructured field as “Ms. Smith is a good student. Suzie is very bright and organized.” The second MLM 318 is able to use the attribute “Susan Smith” to identify “Ms. Smith” and “Suzie” in the unstructured field.

Although the attribute analyzer 310 and the unstructured field analyzer 316 are described as respectively using a first MLM 312 and second MLM 318. However, the function of the first and second MLMs may be performed using a single MLM. In some embodiments, an extra layer of protection is optionally used to ensure specifically known attributes are identified. This extra layer is implemented using a Named Entity Recognition (NER) algorithm that searches for specific, known attributes within the document(s) and flags the additional identified attributes for redaction.

The unstructured field analyzer 316 is coupled to a redactor 320 such that the identified attributes from both structured and unstructured fields are transmitted to the redactor 320. The redactor 320 redacts the attributes from the document to produce a deidentified document. In one embodiment, the redactor 320 replaces the attributes with a predefined character or character string such as XXXXX. Any character or character string may be used.

The deidentified document is then optionally processed by a robustness analyzer 322 that examines the deidentified document using a third MLM 328 to attempt to decipher any attributes from the content of the deidentified document. The third MLM 328 may be, for example, an LLM that is trained to decipher attributes from the content of the deidentified document. If any attributes are found or can be deciphered from the document content, the deidentified document is flagged for further review. More specifically, the robustness analyzer 322 reviews the context of the redacted attributes within the sentences or clauses to determine whether am attribute can be deciphered. In addition, the robustness analyzer 322 determines if any attributes that were to be redacted were missed and left unredacted in the document. The server 108 outputs the deidentified document 324 for storage, further research, return to the user computer that supplied the document, etc.

If further analysis is to be performed, the deidentified document 324 (or a group of deidentified documents) are processed by a document analyzer 326. The document analyzer 326 may be local (executed by the server 108) or remote (executed by a user computer 102 or another server). By analyzing the deidentified documents 324, the document analyzer 326 processes the document in an anonymized manner. For example, IEPs may be analyzed to determine IEP goals vs demographics. Also, IEPs may be analyzed to determine if the IEPs are truly individualized or contains excessive cutting and pasting been used to prepare the IEPs.

In some embodiments, optional feedback 330 may be utilized either via additional MLM functionality or through intervention of a human user. The feedback module creates a feedback loop that reviews at least one of the identified attributes from the unstructured field analyzer 316, the redacted document from the redactor 320 or the flagged attribute(s) identified by the optional robustness analyzer 322 and provides an update of attributes and/or fields to be identified or not identified to the field analyzer 304. This feedback is used to identify attributes that should not be redacted as well as assist the training by identifying additional attributes that should be redacted. The feedback may also be helpful to identify more or less structured fields to include in the document processing. Once feedback is applied, the documents may be reprocessed to effectuate the updates into the redaction process.

FIG. 4 depicts a flow diagram of a method 400 of training at least one machine learning model (MLM) in accordance with at least one embodiment of the invention. The method 400 begins at 402 and proceeds to 404. At 404, the method 400 accesses the training data. In one embodiment, the training data may comprise select sample documents that contain a wide range of exemplary attributes and other sensitive information and the variations of those attributes. Alternatively or in addition, the training data may contain synthetic data that is specifically created to train the MLMs (e.g., MLMs 312, 318, 328). The synthetic data is specifically curated to ensure the MLM is trained to identify attributes as they are used in real-world documents including, but not limited to, misspellings of names and addresses, nicknames, variations in formatting of addresses and phone numbers and the like. In some embodiments, the training data may contain both actual data and synthetic data.

At 406, the training data is applied to the MLMs 312, 318, 328 to train the MLM to perform the desired function. After training, the method 400 ends at 408.

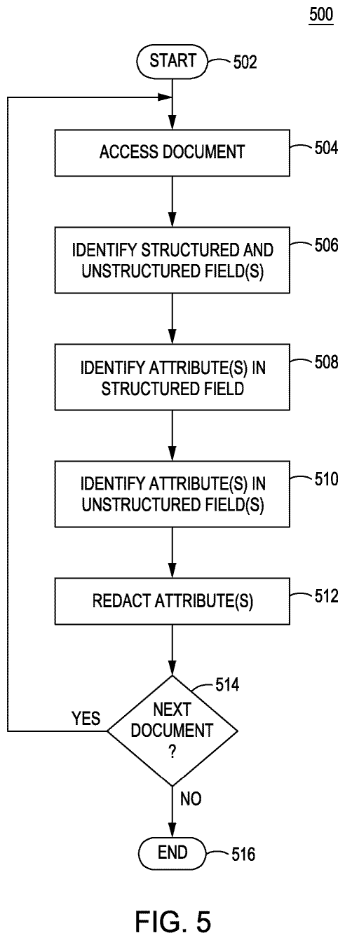

FIG. 5 depicts a flow diagram of a method 500 of performing automated deidentification of documents using at least one machine learning model 312, 318, 328 in accordance with at least one embodiment of the invention. Upon execution of the deidentification software (108 in FIG. 1), the method 500 begins at 502 and proceeds to 504 where the method 500 accesses a document. At 506, the method 500 analyzes the document to identify at least one structured field within the document and, at 508, the method 500 uses the MLM (312 in FIG. 3) to identify at least one attribute (PII and/or other sensitive information) within the identified at least one structured field.

At 510, the method 500 identifies at least one unstructured field in the document and, at 512, the method 500 uses MLM (318 in FIG. 3) to identify the at least one attribute (PII and/or other sensitive information) contained in the at least one unstructured field in the document. At 514, the method 500 redacts the identified attributes from the structured and unstructured fields of the document to form a deidentified document.

At 516, the method 500 queries whether another document is to be deidentified. If the query is affirmatively answered, the method 500 proceeds along path 520 to 504 to access another document. If the query is negatively answered, the method 500 proceeds to 518 and stops.

In some embodiments, the method 500 is performed within a web server such that a user computer (102 in FIG. 1) may access and use the deidentification software without supplying a document to the server for processing. In this manner, the document resides on the user computer while the deidentification software applies method 500 to the document. Consequently, the document and its PII are securely maintained on the user computer and not exposed to potential misappropriation.

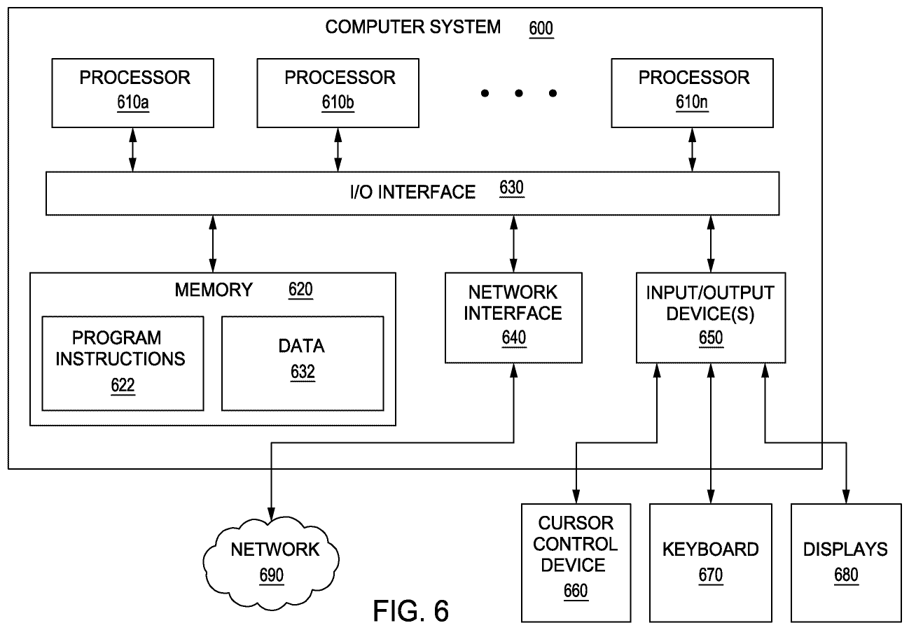

FIG. 6 depicts a computer system 600 that can be utilized in various embodiments of the present invention to implement the computing devices (server 108 of FIG. 1) according to one or more embodiments.

Various embodiments of a deidentification system, as described herein, may be executed on one or more computer systems, which may interact with various other devices. One such computer system is computer system 600 illustrated by FIG. 6, which may in various embodiments implement any of the elements or functionality illustrated in FIGS. 1 through 5. In various embodiments, computer system 600 may be configured to implement methods and functions described above. The computer system 600 may be used to implement any other system, device, element, functionality or method of the above-described embodiments. In the illustrated embodiments, computer system 600 may be configured to implement the deidentification server 108 and implement the deidentification functions as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, tablet or netbook computer, mainframe computer system, handheld computer, workstation, network computer, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any non-transitory computer readable media including any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the functions illustrated by the diagram of FIG. 3. The functional blocks of FIG. 3 may be implemented in the user device or may be implemented partially in the user device and partially in a server. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. An apparatus configured to deidentify a document comprising:
a field analyzer for identifying at least one structured field and at least one unstructured field within a document;
an attribute analyzer, using a first machine learning model and the identified at least one structured field and at least one unstructured field, for identifying at least one attribute within the document;
an unstructured field analyzer, using a second machine learning model and the identified at least one attribute from the at least one structured field, for identifying at least one attribute within the at least one unstructured field; and
a redactor for redacting the identified attributes in the at least one structured field and the at least one unstructured field to form a deidentified document.

2. The apparatus of claim 1, wherein the field analyzer has knowledge of a location for the at least one structured field and the at least one unstructured field within the document.

3. The apparatus of claim 1, wherein the field analyzer determines a location for the at least one structured field and the at least one unstructured field within the document.

4. The apparatus of claim 1, further comprising a robustness analyzer comprising a third machine learning model for reviewing the deidentified document to decipher any attributes from the content of the deidentified document.

5. The apparatus of claim 1, wherein synthetic training data is used to train the first and second machine learning models.

6. The apparatus of claim 1, wherein the unstructured field analyzer determines a context of a sentence containing the at least one attribute to confirm the identified attribute is sensitive information.

7. The apparatus of claim 1, wherein the at least one attribute comprises personally identifiable information.

8. The apparatus of claim 1, further comprising a feedback module, coupled to at least one of the unstructured field analyzer or the redactor, to review at least one of the identified attributes or the redacted document and update the fields identified by the field analyzer.

9. A method for deidentifying a document comprising:
accessing a document;
identifying at least one structured field in the document;
using a first machine learning model to identify at least one attribute in the at least one structured field;
identifying at least one unstructured field in the document;
using a second machine learning model and the identified at least one attribute from the at least one structured field to identify at least one attribute in the at least one unstructured field;
redacting the identified at least one attribute from the structured and unstructured fields from the document to produce a deidentified document.

10. The method of claim 9, wherein identifying the at least one structured field is performed with knowledge of a location of the structured field within the document.

11. The method of claim 9, further comprising performing a robustness analysis on the deidentified document to decipher any attributes from the content of the deidentified document.

12. The method of claim 9, wherein synthetic training data is used to train the first and second machine learning models.

13. The method of claim 9, wherein identifying the PII in the at least one unstructured field further comprises determining a context of a sentence containing the at least one attribute to confirm the identified at least one attribute is sensitive information.

14. The method of claim 9, wherein the at least one attribute comprises personally identifiable information.

15. An apparatus comprising at least one processor and at least one non-transient computer readable media, where the at least one non-transient computer readable media stores instructions that, when executed by the at least one processor, causes the apparatus to perform operations comprising:
accessing a document;
identifying at least one structured field in the document;
using a first machine learning model to identify at least one attribute in the at least one structured field;
identifying at least one unstructured field in the document;
using a second machine learning model and the identified at least one attribute from the at least one structured field to identify at least one attribute in the at least one unstructured field;
redacting the identified at least one attribute from the structured and unstructured fields from the document to produce a deidentified document.

16. The apparatus of claim 15, wherein identifying the at least one structured field is performed with knowledge of a location of the structured field within the document.

17. The apparatus of claim 15, further comprising performing a robustness analysis on the deidentified document to decipher any attributes from the content of the deidentified document.

18. The apparatus of claim 15, wherein synthetic training data is used to train the first and second machine learning models.

19. The apparatus of claim 15, wherein identifying the PII in the at least one unstructured field further comprises determining a context of a sentence containing the at least one attribute to confirm the identified at least one attribute is sensitive information.

20. The apparatus of claim 15, wherein the at least one attribute comprises personally identifiable information.
